(19) United States
(12) Patent Application Publication
(10) Pub. No.: US 2014/0282478 A1
(43) Pub. Date: Sep. 18, 2014

(54) TCP SERVER BOOTLOADER

(71) Applicant: Silicon Graphics International Corp., Fremont, CA (US)

(72) Inventor: Bradley Enoch Huntting, Boulder, CO (US)

(73) Assignee: Silicon Graphics International Corp., Fremont, CA (US)

(21) Appl. No.: 13/897,198

(22) Filed: May 17, 2013

Related U.S. Application Data
(60) Provisional application No. 61/789,681, filed on Mar. 15, 2013.

(51) Int. Cl. G06F 9/445

(52) U.S. Cl. CPC G06F 8/66
USPC 717/171

(57) ABSTRACT

A bootloader uses a TCP server to install and verify upgrades on a networked computing device such as a storage enclosure. A data management server client may connect to a bootloader on the storage enclosure using TCP. Once the connection is established, an upgrade image (upgrade data) can be provided directly to the bootloader and installed by the bootloader at the storage enclosure. The TCP server allows for the upgrade to be installed with minimal steps and a simple interface.

### CROSS REFERENCE TO RELATED APPLICATIONS

This application claims the priority benefit of U.S. Provisional Application Ser. No. 61/789,681, titled “TCP Server Bootloader,” filed Mar. 15, 2013, the disclosure of which is incorporated herein by reference.

### BACKGROUND OF THE INVENTION

1. Field of the Invention

The presently claimed invention relates to boot loading software. In particular, the present invention relates to installing and verifying an upgrade via a bootloader over a network.

2. Description of the Related Art

As data storage systems evolve and new technology is developed, data storage enclosure units require updates. Upgrades are typically provided to storage enclosures over a network or through a serial port. Most commonly, the upgrades over a network use the trivial file transfer protocol (TFTP). A bootloader typically runs on the storage enclosure being upgraded and acts as a TFTP client. FIG. 1 is a block diagram of a storage enclosure bootloader of the prior art. The system of FIG. 1 includes data management server 110, storage enclosure 120, and update server 130. Data management server 110 operates as a server and communicates with the TFTP client 125 on a storage enclosure 120. Server 110 provides a network address and server information to the TFTP client 125. The client 125 receives the information and requests data from the server at the particular address. Update server 130 resides at the address, receives the requests, retrieves the data, and provides the data to the requesting TFTP client 125. TFTP client 125 receives the data and installs the upgrade at storage enclosure 120.

There are some disadvantages with using a TFTP client as a bootloader for a storage enclosure. Though the TFTP protocol is simple and allows the client to drive the network protocol, it requires multiple steps to get the update to the storage enclosure. First, the instructions and location of the update must be provided to the client. The client must then retrieve the instructions from the provided address. Once the instructions and data are received, the TFTP client can load the upgrade to the storage enclosure. The multiple steps required for using a TFTP client as a bootloader in a storage enclosure within a data center are time consuming and error prone. There is a need for a simpler network-based upgrade method for upgrading a storage enclosure.

### SUMMARY OF THE CLAIMED INVENTION

The present invention utilizes a bootloader with a TCP server to install and verify upgrades on a network device such as storage enclosure. A data management server client may connect to a bootloader TCP server on the storage enclosure. Once the connection is established, the upgrade can be provided directly to the bootloader and installed by the bootloader or compared with currently installed images on the storage enclosure. The TCP server allows for the upgrade to be installed with minimal steps and a simple interface.

An embodiment for upgrading a network computing device may begin with using a bootloader with a TCP server at the network computing device. Upgrade data may be received by the network computing device using a TCP connection with the TCP server. The upgrade data may then be installed.

An embodiment of a network computing device may include a processor, memory and one or more modules stored in memory and executable by the processor. When executed, a module may use a bootloader with a TCP server at the network computing device, receive upgrade data using a TCP connection with the TCP server, and install the upgrade data.

### BRIEF DESCRIPTION OF THE DRAWINGS

FIG. 1 is a storage enclosure bootloader of the prior art.

FIG. 2 is a storage enclosure bootloader of the present invention.

FIG. 3 is a method for upgrading a network computing device using a TCP server.

FIG. 4 is a block diagram of a computing device for implementing a data management server.

### DETAILED DESCRIPTION

A Terminal Control Protocol (TCP) server on a bootloader to install and verify upgrades at a networked computing device in communication with a network, such as a networked storage enclosure, is disclosed. A data management server client may connect to a bootloader TCP server on a storage enclosure. Once the connection is established, an upgrade can be provided directly to the bootloader on the storage enclosure. The TCP server allows for the upgrade to be installed with minimal steps and a simple interface.

Though an embodiment involving a storage enclosure is referred to herein, the references are exemplary and for purposes of discussion. The present invention, the implementation of a boot loader using a TCP server, may be implemented with a variety of devices that are communicatively coupled to a network. The present invention is not intended to be limited to a storage enclosure.

FIG. 2 is a storage enclosure with a bootloader of the present invention. The system of FIG. 2 includes data management server 210 and network computing device 220. Data management server 210 includes a TCP client 215. The TCP client 215 may initiate a connection with a TCP server and provide upgrade data to the TCP server over a network such as the Internet.

Network computing device 220 may communicate over a network, such as the Internet. In an embodiment, network computing device 220 may be one of many storage enclosures implemented in a data center. Network computing device 220 may be upgraded and provided with other information remotely through a bootloader with a TCP server 225. The bootloader may listen for and accept a connection from client 215, receive a command to implement an upgrade, receive the upgrade data, and process the upgrade either by installing it, or by comparing it to images already installed.

FIG. 3 is a method for providing an upgrade on a network computing device using a TCP server. First, a TCP server may be configured at the network computing device at step 310. In configuring, the TCP server may allocate a port and instruct a stack to listen for a connection at the port. A client may initiate a TCP session at step 320. In some embodiments, the TCP server may be configured to wait for a period of time for a connection from a remote management server. In some embodiments, the TCP server may wait for a period of 15 seconds.

A TCP connection is established between the TCP server 225 and TCP client 215 at step 330. TCP client 215 may send a command to install or verify upgrade data to TCP server 225 at step 340. Client 215 may then transmit the upgrade data to TCP server 225 at step 350. The data may be streamed over a network from the data management server 210 to the TCP server 225.

The TCP server in the bootloader receives the upgrade data at step 360 and either loads the data into ROM of the data enclosure, or compares the data to the ROM of the data enclosure at step 370. In some embodiments, the TCP server bootloader may flash write data into the ROM of the data enclosure. The flash may be done on the fly by the bootloader without waiting for the entire upgrade image to download.

In some instances, all or a portion of the data may not be stored into device ROM. For example, the upgrade data may not installed, but rather may be checked against data images previously installed and a report is sent back through the TCP connection to indicate whether the data sent matches the currently written data.

FIG. 4 is a block diagram of a computing device for implementing data management server 210 and embodiments of network computing device 220. The computing system 400 of FIG. 4 includes one or more processors 410 and memory 420. Main memory 420 stores, in part, instructions and data for execution by processor 410. Main memory 420 can store the executable code when in operation. The system 400 of FIG. 4 further includes a mass storage device 430, portable storage medium drive(s) 440, output devices 450, user input devices 460, a graphics display 470, and peripheral devices 480.

The components shown in FIG. 4 are depicted as being connected via a single bus 490. However, the components may be connected through one or more data transport means. For example, processor unit 410 and main memory 420 may be connected via a local microprocessor bus, and the mass storage device 430, peripheral device(s) 480, portable storage device 440, and display system 470 may be connected via one or more input/output (I/O) buses.

Mass storage device 430, which may be implemented with a magnetic disk drive or an optical disk drive, is a non-volatile storage device for storing data and instructions for use by processor unit 410. Mass storage device 430 can store the system software for implementing embodiments of the present invention for purposes of loading that software into main memory 420.

Portable storage device 440 operates in conjunction with a portable non-volatile storage medium, such as a floppy disk, compact disk or Digital video disc, to input and output data and code to and from the computer system 400 of FIG. 4. The system software for implementing embodiments of the present invention may be stored on such a portable medium and input to the computer system 400 via the portable storage device 440.

Input devices 460 provide a portion of a user interface. Input devices 460 may include an alpha-numeric keypad, such as a keyboard, for inputting alpha-numeric and other information, or a pointing device, such as a mouse, a trackball, stylus, or cursor direction keys. Additionally, the system 400 as shown in FIG. 4 includes output devices 450. Examples of suitable output devices include speakers, printers, network interfaces, and monitors.

Display system 470 may include a liquid crystal display (LCD) or other suitable display device. Display system 470 receives textual and graphical information, and processes the information for output to the display device.

Peripherals 480 may include any type of computer support device to add additional functionality to the computer system. For example, peripheral device(s) 480 may include a modem or a router.

The components contained in the computer system 400 of FIG. 4 are those typically found in computer systems that may be suitable for use with embodiments of the present invention and are intended to represent a broad category of such computer components that are well known in the art. Thus, the computer system 400 of FIG. 4 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for upgrading a network computing device, the method comprising:
using a bootloader with a TCP server at the network computing device;
receiving upgrade data using a TCP connection with the TCP server; and
installing the upgrade data.

2. The method of claim 1, wherein the TCP connection is initiated from a remote client.

3. The method of claim 1, wherein the upgrade data includes a stream of data for installation by the bootloader.

4. The method of claim 1, wherein the data is installed by the bootloader by flashing the data into ROM.

5. The method of claim 1, wherein the upgrade data is not installed, but rather checked against images previously installed and a report is sent back through the TCP connection to indicate whether the data sent matches.

6. The method of claim 1, wherein the network computing device is a storage server.

7. A network computing device for providing an upgrade, comprising:
a processor;
a memory;
one or more modules stored in memory and executable by the processor to use a bootloader with a TCP server at the network computing device, receive upgrade data using a TCP connection with the TCP server, and install the upgrade data.

8. The network computing device of claim 1, wherein the TCP connection is initiated from a remote client.

9. The network computing device of claim 1, wherein the upgrade data includes a stream of data to be installed by the bootloader.

10. The network computing device of claim 1, wherein the data is installed by the bootloader by flashing the data into ROM.

11. The network computing device of claim 1, wherein the upgrade data is not installed, but rather checked against images previously installed and a report is sent back through the TCP connection to indicate whether the data sent matches.

12. The network computing device of claim 1, wherein the network computing device is a storage server.
